(19) United States
(12) Patent Application Publication
(10) Pub. No.: US 2024/0325925 A1
(43) Pub. Date: Oct. 3, 2024

(54) DETECTING ANOMALOUS GAMEPLAY IN VIDEO GAMES

(71) Applicant: Electronic Arts Inc., Redwood City, CA (US)

(72) Inventor: Mohammad Shams, Irvine, CA (US)

(21) Appl. No.: 18/622,709

(22) Filed: Mar. 29, 2024

Related U.S. Application Data
(60) Provisional application No. 63/455,730, filed on Mar. 30, 2023.

(51) Int. Cl. A63F 13/75

(52) U.S. Cl. CPC A63F 13/75

(57) ABSTRACT

Gameplay API (G-API) calls are embedded by an anomaly system to detect anomalous gameplay among a video game. Anomalous gameplay is detected by identifying anomalous sequences of G-API calls made during gameplay. Anomalous gameplay can correspond to issues that disrupt and/or degrade the user experience of a video game; such as the existence of a bug or exploit, or the use of cheats, and/or bots by users of a video game. A machine learning embedding model among an anomaly system is trained to embed G-API calls corresponding to a video game. Once trained, a distance analysis and distribution analysis is performed by the anomaly system on embedded G-API calls to detect anomalies among the G-API calls made by a video game. Data corresponding to the detected anomalies can be included among a generated anomaly detection report by the anomaly system for further analysis, such as by video game developers.

### CROSS REFERENCE TO RELATED APPLICATIONS

Any and all applications for which a foreign or domestic priority claim is identified in the Application Data Sheet as filed with the present application are incorporated by reference under 37 CFR 1.57 and made a part of this specification.

### BACKGROUND

As video games grow in size and complexity, the need to detect anomalous gameplay (e.g., runtime issues including bugs and/or exploits) grows in unison. Identifying anomalous gameplay in video games is paramount to preserving and maintaining the integrity and quality of a video game; as some users will seek to use and/or invoke gameplay anomalies to gain an unfair advantage in gameplay, which ultimately degrades the experience for other users. Therefore, it is optimal and desirable for an anomaly detection system to detect anomalous gameplay among video games, such as through the analysis of application programming interface (API) calls that correspond to gameplay.

### BRIEF DESCRIPTION OF THE DRAWINGS

This disclosure will be more fully understood from the following detailed description taken in conjunction with the accompanying drawings, in which:

FIG. 1 is a system diagram of a gaming environment 100 according to an example embodiment;

FIG. 2 illustrates a process of an anomaly system according to an example embodiment;

FIG. 3 illustrates a system diagram corresponding to an anomaly system, according to an example embodiment;

FIG. 4 illustrates the embedding of G-API calls for anomaly reporting, according to an example embodiment;

FIG. 5 illustrates an embodiment of a computing device.

### DETAILED DESCRIPTION

The systems and methods described herein detect anomalous activities among video games and/or virtual social spaces by way of an anomaly system. An anomaly system is configured with executable instructions that perform embedding on application programming interface (API) calls corresponding to activities, such as gameplay, to analyze the embedded API calls to detect and/or report anomalies.

As known to a person of ordinary skill in the art, an API call (commonly known as an “API request”; or as “calls” and “requests” in short) is a string (e.g., of text and/or characters) used in part to communicate (e.g., call or request) data or the execution of one or more functions and/or instructions among and/or between one or more software applications and/or software services.

The present disclosure provides for an anomaly system among software applications, such as video game applications, to embed API calls into a vector through word embedding; a technique—as known to a person of ordinary skill in the art—for mapping (e.g., converting and/or representing) a string (e.g., of text and/or characters) into a vector: such as a vector of real values. As used herein, the terms “vectorize” and “embedding” refers to the process of word embedding, and the terms “vectorized” and “embedded” refers to the corresponding output of a word embedding (e.g., a vector of real values). As used herein, “API Embedding” (and also “embedding” in short) refers to the word embedding of API Calls, including gameplay API calls.

In video game applications, API calls and requests can be configured and made in part to call functions or execute instructions corresponding to the navigation among interfaces, gameplay, and/or requesting, access, and communicating data, such as game data, among users and/or services. As used herein, G-API calls (hereinafter “G-API Calls” in short) refers to API calls of a video game application, video game platform, and/or video game services. Therefore, G-API are used to refer to any instruction, command, execution, call, and/or request made by or among a video game application, video game platform, and/or video game services. Furthermore, a user's input to and/or control of a video game application can associate respectively produced G-API calls to the user and/or user account.

The API embedding of an anomaly system of a video game application is based in part on a fully connected neural network machine learning model, such as “word-to-vector” model, that is trained in part on gameplay data to provide word embedding to G-API calls. Once trained, the inference (e.g., runtime) of the machine learning model can embedded G-API calls based in part on the learned vector space mappings from the G-API calls provided during training. The machine learning model of the anomaly system can perform inference during the runtime of a video game and/or at a time thereafter.

In some embodiments, the output of this machine learning model is a vector of real values, such that the values are a deterministic representation of a G-API call. For simplicity, the output of this machine learning model is referred to as an “embedded G-API call” and the learned vector mapping space of the model represents a “library” of embedded G-API calls.

After inference, an anomaly system can analyze one or more embedded G-API calls to determine or identify anomalous sequences of G-API calls. As such, the analysis can be a sequential analysis of G-API calls (e.g., in the order they are made) to determine or identify whether the sequences analyzed are anomalous (e.g., unexpected). Here, an anomalous or unexpected sequence of embedded G-API calls corresponds to the distance and distribution between the vector values of the respective API embeddings.

As such, an anomaly system is further configured to determine the distance between the vector values of embedded G-API calls, such as by way of a Euclidean distance. To determine whether distance between sequential G-API calls is unexpected or uncommon, anomaly system can perform a distribution analysis on the distance result to determine how uncommon the distance is with respect to how it compares or lies to a relative distribution curve. For simplicity, the term “analysis” can be used interchangeably to refer to sequential analysis, distance analysis, and/or distribution analysis of the anomaly system.

Based on the results of the analysis, an anomaly system can determine or identify an anomalous sequence of G-API calls. Thereafter, a report based at least in part on this determination (e.g., the results of the analysis) can be generated and made available, such as to developers who can address or remedy the anomaly.

Advantageously, detection of an anomalous sequence of G-API calls corresponds to issues that disrupt and/or degrade the user experience of a video game, such the use of exploits, cheats, and/or bots by users. As such, reports generated and/or provided by a reporting module can be used in part to maintain and preserve the integrity and quality of a video game, and/or gaming environment thereof.

### Gaming Environment

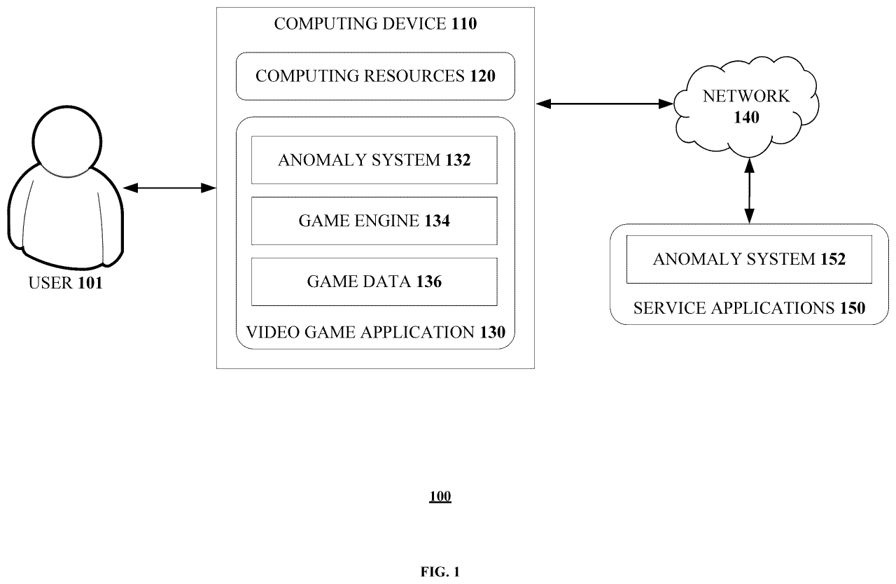

FIG. 1 is a system diagram of a gaming environment 100 according to an example embodiment. As shown in FIG. 1, the environment 100 includes a computing device 110 that is associated with—or operated and/or controlled by—a user 101 (also referred to herein interchangeably as “player” or “player 101”). As described herein, the gaming environment 100 enables users to execute and/or play video games applications (or “video game” in short) that can detect anomalous gameplay through their computing devices.

As known to those of skill in the art, user 101 can operate or control the computing device 110, such as for playing a video game application, through inputs provided via input devices of, or associated with, computing device 110. User 101 can provide inputs to the computing device 110 through one or more input devices (e.g., controller, keyboard, mouse, touchscreen, camera, microphone, etc.) associated with the computing device 110. Computing device 110 can output, communicate and/or provide information (e.g., display, render, play audio) to user 101 through one or more output devices (e.g., monitor, screen, touchscreen, speaker, haptics, etc.) associated with computing device 110.

User 101 can be a and/or an automated agent (hereinafter “agent” in short). As known to a person of ordinary skill in the art, an “agent” can include a machine learning model and/or software to automate or perform one or more tasks (e.g., playing or testing a video game). For instance, agents can function as users 101 and be deployed, controlled, and/or directed by computing device 110 to perform and/or automate one or more tasks in computing devices 110 through techniques known to those of skill in the art.

Computing device 110 can be or include any one or a combination of systems known to those of skill in the art, including, for example, a desktop, laptop, game application platform, game console, virtual reality system, augmented reality system, television set-top box, television, network-enabled kiosk, car-console devices computerized appliance, wearable device (e.g., smart watch, glasses with computing functionality), and wireless mobile devices (e.g., smart phones, PDAs, tablets). The example computing device 110 can store and/or execute computer executable instructions (or code) of applications (or programs or software), such as video game applications, interactive applications, and/or other applications known to those of skill in the art that could include or benefit from the systems and methods described herein.

Computing resources 120 of computing device 110 include hardware and software components that can be used to execute a video game application, among other applications; including, for example, central processing units (CPUs), memory, mass storage, graphics processing units (GPUs), communication or networking components, input devices and/or output devices (I/O devices). It should be understood that the computing device 110 can include any number and/or combination of computing resources; including those described herein and others known to those of skill in the art.

Video game application 130 includes data and software that provides gameplay and other features to users (or “players”) of a video game during execution. For example, executing video game application 130 can cause an instance of the video game to be generated. Each instance can be referred to as a “game session” or “gameplay session”. The game session can be made up of or include one or more virtual interactive environments. A virtual interactive environment can be or include one or more virtual levels, virtual social spaces, and/or graphical user interfaces that can be interacted with or in, for gameplay or socializing. As such, a game session can include, host, or enable—for users-participation and interaction by or with player characters, non-player characters, quests, objectives, and other features, elements, assets, objects or the like known to those of skill in the art.

As illustrated in FIG. 1, by way of example and not limitation, video game application 130 includes anomaly system 132, game engine 134, and game data 136. As known to a person of ordinary skill in the art, a game engine uses game data (e.g., state data, render data, simulation data, audio data, and other data types of the like) to generate and/or render one or more outputs (e.g., visual output, audio output, and haptic output) for one or more computing devices. In some embodiments, game engine 134 includes underlying frameworks and software that execute game code (e.g., gameplay instructions) of video game application 130 for generating game sessions. In some embodiments, game data 136 includes state data, simulation data, rendering data, audio data, animation data, and other data-including game code-used and/or produced by or among game engine 134 during execution.

Anomaly system 132 includes software configured with computer executable instructions to embed and analyze G-API calls to detect and report anomalous G-API sequences.

G-API calls can be captured and/or saved as, or among, one or more data files and stored among one or more data stores or buffers corresponding to computing device 110 (e.g., as game data 136). For simplicity, a “G-API call” can be any command, request, instruction, function, and/or other communications made during the runtime of video game application 130, including those made by user input or among game engine 134 and service applications 150, among other things.

As a non-limiting illustrative example, G-API calls can correspond to instructions for rendering, simulation, graphics, gameplay, user interfaces, communications, matchmaking, user account permissions, inputs, outputs, progression and among other aspects of a video game. For instance, G-API call can be made in response to, and/or based in part on, gameplay and/or other executable instructions occurring during the runtime of a video game, such as loading and/or updating of game data, levels, menus, and/or instantiation of gameplay objects. As a non-limiting illustrative example, the proceeding strings are G-API calls that can be made, communicated, and stored (as game data) among gaming environment 100:
“VERIFY: PLAYER_ACCOUNT”
“CONNECT: MAIN_LOBBY”
“CONNECT: MULTIPLAYER_MODE_1”
“LOAD: MAP_02A”
“UPDATE: PLAYER_001 POSITION”
“UPDATE: PLAYER_001_STATUS”
“UPDATE: TEAM_R5_SCORE”.

Network 140 includes any method of private and/or public connectivity, networking, and/or communication between or among hardware devices known in the arts. The network may be or include direct wired connections, Near Field Communication (NFC), a Local Area Network (LAN), a Virtual Private Network (VPN), an internet connection, or other communication methods known to those of skill in the art. As illustrated, network 140 communicatively couples computing device 110 to service applications 150.

Service applications 150 provide services to video game application 130. As known to a person of ordinary skill in the art, service applications are software that provide functionality and/or data to other software applications. Services can be provided remotely over a network (commonly known as a “software as a service” or “SaaS” in short) or locally among a system. It should be understood that service applications 150 operate and/or execute a system and/or computing device(s) with computing resources (commonly known as a server); which can be similar to computing device 110.

Service applications 150 can include “gameplay services” corresponding to one or more aspects or features of a video game application, including matchmaking services, communication services, game state management, data storage, and anti-fraud detection, and other game related services of the like. In turn, the service applications 150 can be used to establish and maintain connections among computing devices, video game applications, and/or users that, at least in part, facilitate gameplay parties, player communications, multiplayer gameplay and other interactions corresponding to a video game application and/or user platform corresponding to video games. Additionally, service applications 150 can include a video game platform corresponding to video game applications. User accounts of the video game platform include data provided by users, such as a username, that identifies a user among gaming environment 100. The video game platform enables a user account to access and/or manage software and/or services of gaming environment 100 for gameplay, such for multiplayer gameplay and other online gameplay features of the like.

Anomaly system 152 of service applications 150 includes software configured with computer executable instructions to embed and analyze G-API calls to detect and report anomalous G-API sequences. In some embodiments, anomaly system 152 is similar to anomaly system 132 of video game application 130 and provides similar functionality as a service among gaming environment 100. Anomaly system 132 and anomaly system 152 include one or more software and/or hardware modules configured with computer executable instructions for embedding G-API calls and for performing a distance analysis and distribution analysis on the embedded G-API calls to detect and/or report anomalous gameplay.

### Process

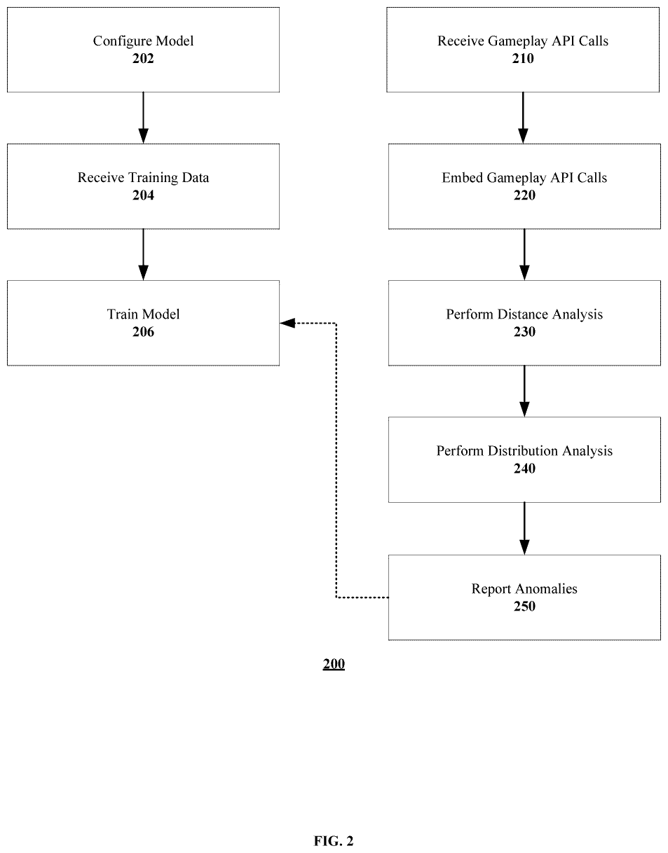

FIG. 2 illustrates a process of an anomaly system according to an example embodiment. Process 200 corresponds to an anomaly system similar to anomaly system 132 and 152 of FIG. 1.

At step 202, a machine learning model of an anomaly system, such as a word-to-vector model, is configured. Here, an anomaly system is configured with an encoding technique that provides a vector space represented in real number values (e.g., vectors with elements of real number values). As known to a person of ordinary skill in the art, a vector space can be configured to produce embeddings of a fixed or dynamic vector size. This vector space size is commonly based in part on the size or scope of the training data, such that the size correlates to the necessary amount of vector elements required to provide deterministic or unique vector value representations for input data.

As such, the configuration at step 202 enables a vector space of a machine learning model of an anomaly system to provide deterministic and unique vector representations for each unique G-API call provided to the model and/or anomaly system. As a non-limiting illustrative example, the configured vector space of the machine learning model of an anomaly system is configured as a vector of six elements, but other fixed or dynamic sizes may also be used.

Additionally, by configuring the model and vector space to use vectors of real number values, the model can learn semantic similarity among training data to apply to the vector space. As known to a person of ordinary skill in the art, the “vector space” of a word embedding technique (also commonly known as a “linear space”) corresponds to the mapping, translation, representation and/or conversion of data (e.g., strings) into vectors, and “semantic similarity” corresponds to the assignment of values (e.g., of vectors) for the mapping of data (e.g., strings) based in part on the organization, ordering, relation, and/or occurrences of data among a data set (e.g., training data), among other things.

At step 204, the model of an anomaly system receives training data. In some embodiments, training data includes real and/or mock (e.g., simulated) G-API calls corresponding to one or more video game applications.

At step 206, the model of an anomaly system is trained based in part on the training data received. The training or learning of semantic similarity of the model is based in part on ordering, sequences, and/or organization of data (e.g., G-API calls) among the training data.

As such, the sequence or order of G-API calls among the training data can correspond to the expected and/or anticipated gameplay or user experience of a video game, such that the semantic similarity learned by the model at training corresponds or conforms to “normal” or “expected” gameplay among a video game. In some embodiments, training data includes G-API calls captured over the course of gameplay of a video game application. By capturing G-API calls during gameplay, training data can more accurately and/or appropriately enable a model to learn semantic similarity.

As a result, and beneficially, the model of an anomaly system is trained to assign (e.g., map, convert, and/or represent) the vector values of G-API calls that commonly occur near and/or close to one another during gameplay closer in value. Similarly, the model of an anomaly system is trained to convert G-API calls (e.g., strings) that do not commonly occur near and/or close to one another during gameplay to vectors of real number values that are further in value.

The anomaly system can also be configured-such as during or after training of a model among steps 202 through 206—with deterministic logic to perform distance analysis and distribution analysis on the output of the model (e.g., vectors) and generate anomaly reports based in part on the results thereafter.

Once trained and configured, an anomaly system can be used during gameplay of a video game to detect anomalous gameplay. For instance, during the runtime of a video game application, such as among navigating the menus of the video games or during a game session of the video game (e.g., gameplay), an anomaly system can monitor the G-API calls made. As such, interactions among any aspect, interface, feature, or game mode of a video game can be monitored for anomalous gameplay sequences. As such, an anomaly system can detect anomalies that do and don't correspond to gameplay, including, for example, interactions by users with gameplay services and/or other users.

At step 210, an anomaly system receives G-API calls. In some embodiments, anomaly system can be configured to request, receive, access and/or read data corresponding to or including G-API calls, such as game data. In some embodiment, an anomaly system can receive G-API calls as they are individually made. Alternatively, an anomaly system can receive one or more G-API calls after they are made, such as during or after runtime.

At step 220, an anomaly system embeds the received G-API calls. As a non-limiting example, the G-API call “BEGIN GAMEPLAY” will be deterministically mapped, converted, and/or represented as a vector “[3,1,1,1,2,0]” each time it is received by the anomaly system.

At step 230, an anomaly system performs a distance analysis by calculating the distance of sequential G-API calls that are made during runtime and/or gameplay of a video game. For simplicity, an anomaly system calculates or determines a Euclidean distance between sequential G-API calls.

At step 240, an anomaly system performs a distribution analysis by applying the resulting distance to a distribution curve. In some embodiments, an anomaly system is configured with one or more formulas and/or algorithms for calculating a distribution, such as probability, normal, binormal, gaussian, and other distributions of the like.

The results of the distribution analysis and the preceding steps, in addition to game data corresponding to the G-API calls, can be sent and/or made available to other systems, applications, or modules among a corresponding gaming environment, video game application, video game platform, or video game service applications, such as for generating an anomaly report.

At step 250, an anomaly system can detect and/or report anomalies among the received G-API calls. The anomaly system can create or generate anomaly reports based in part on the results or data processed among process 200. An anomaly report can include game data corresponding to the anomalous G-API call sequences reported, including state data of a video game describe the state, or portion thereof, of the video game; including state data from the time between when the G-API calls are made to a time proximate to when the G-API calls are made.

After step 250, the anomaly reports generated, corresponding game data, and the remedies made by developers can be used in part to retrain the machine learning model of the anomaly system. As such, the machine learning model can be updated such that the vector space of the model is updated so that the semantic similarity is improved.

For example, if a reported anomaly was a false positive, the model can be updated such that semantic similarity between the corresponding G-API calls is closer in values to avoid a subsequent false positive for the occurrence of that respective G-API call sequence. As another example, if the developers cause a change or update to the video game in response to the identified anomalous sequence, or for providing new content to the video game, any newly introduced G-API calls to the video game application can be learned by the machine learning model and mapped accordingly to the vector space, such that semantic similarity of those G-API calls is learned and fit within the vector space, or expanding the vector space size as necessary.

The steps and process of FIG. 2 can be associated with one or more hardware and/or software modules configured with computer-executable instructions. A person of ordinary skill in the art would recognize and appreciate how the proceeding process may be configured in many ways, such that one or more of steps are performed before, after, or simultaneously among other steps, and/or otherwise omitted or substituted in whole or in part.

### Anomaly System

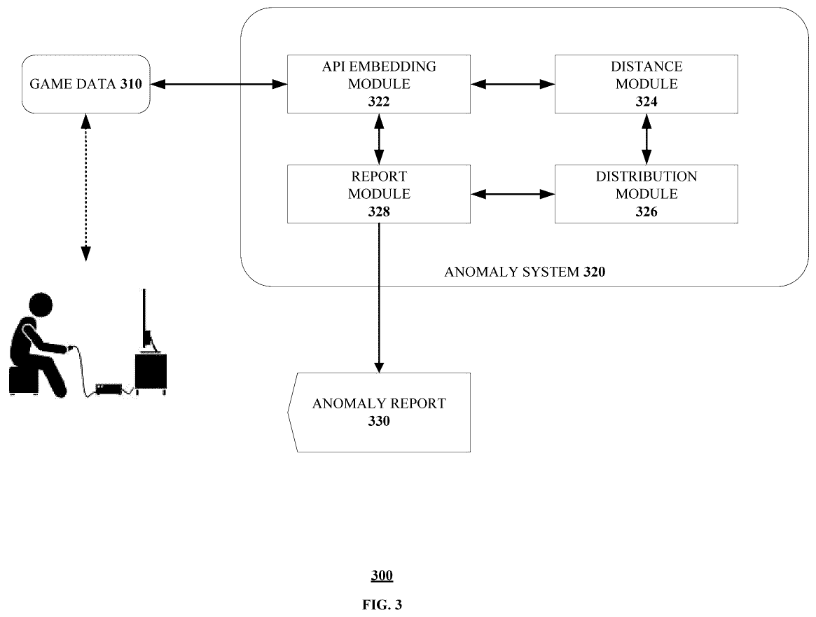

FIG. 3 illustrates a system diagram corresponding to an anomaly system, according to an example embodiment. Process 300 corresponds to the runtime of a video game application and anomaly system, similar to video game application 130, anomaly system 132, and anomaly system 152 of FIG. 1.

As shown, process 300 generates anomaly reports based in part on user input to the video game during runtime. Here, game data 310 includes, among other things, sequential G-API calls of a video game application made in part, or in response to, user input directing and/or controlling one or more aspects, features, or gameplay of the video game.

API embedding module 322 is configured to receive game data 310 for API embedding. API embedding module 322 includes a trained machine learning model to perform API embedding of G-API calls with semantic similarity; as described among the detailed description, including the description of FIG. 1 and FIG. 2.

Distance module 324 is configured to receive the embedded output corresponding to game data 310 to perform a Euclidean distance analysis on one or more sequential G-API calls: as described among the detailed description of FIG. 2.

Distribution module 326 is configured to receive the output and/or results of distance module 324 to perform a distribution analysis: as described among the detailed description of FIG. 2.

Report module 328 is configured to generate anomaly reports, such as anomaly report 330, based in part on the results of modules 322, 324, and 324, and game data 310: as described among the detailed description of FIG. 2.

Anomaly report 330 is generated from report module 328 can be sent or made accessible to services corresponding to a video game application: as described among the detailed description of FIG. 2.

In some embodiments, an anomaly report includes game data corresponding to the anomalies that enable the replication or simulation of the reported anomalies as they occurred. In turn, developers of the video game can analyze the reported anomalies (therein) to develop and/or deploy one or more updates to the video game application and/or video game services that address and/or remedy the anomalies.

### Anomaly Report

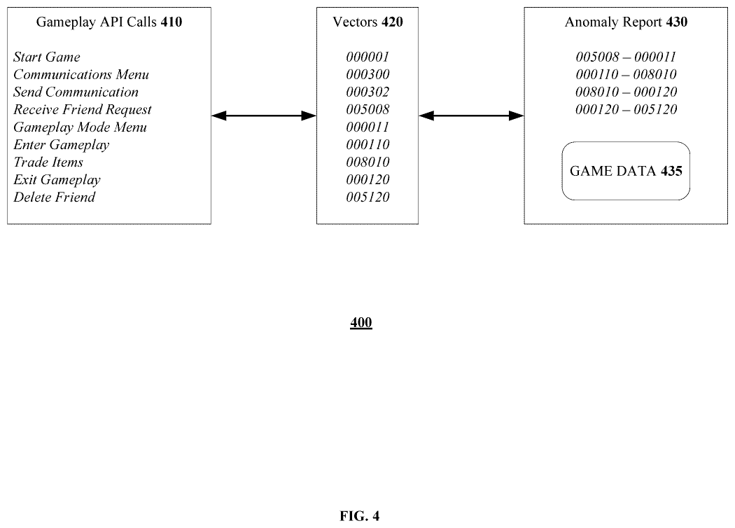

FIG. 4 illustrates the embedding of G-API calls for anomaly reporting, according to an example embodiment. Illustration 400 provides a non-limiting illustrative example of API embedding and anomaly reporting of G-API calls by an anomaly system of a video game, similar to video game application 130 of FIG. 1.

As shown, G-API calls 410 are a set of calls made during the gameplay of a video game. The calls among G-API calls 410 can be sent to anomaly system 152 as they are made, or periodically, or after gameplay of the video game has ended.

Vectors 420 include a set of vectors that corresponded to the calls among G-API calls 410. The vectors among vectors 420 are embedded by an anomaly system of a video game. As shown, the set of vectors are vectors with six elements of real number values. Each vector among vectors 420 respectively corresponds to one embedded G-API call 410 among; for instance, the vector “000001” corresponds to “Start Game”.

An anomaly system of a video game application can use vectors 420 to produce anomaly report 430. As shown, anomaly report 430 includes pairs of sequential (embedded) G-API calls; such as, for example, “005008-00001” corresponding to G-API calls “Receive Friend Request” and “Game Mode Menu”.

In some embodiments, each pair of sequential G-API call can correspond to anomalous sequence in gameplay. An anomalous sequence of G-API calls can indicate the presence of an exploit or issue (e.g., a “bug”) among the video game application. Alternatively, an anomalous sequence of G-API can also indicate an uncommon sequence of G-API calls. As such, an anomaly report 430 can also include data scoring, ranking, or valuing each reported anomalous sequence, which indicates a likelihood of the presence of an issue or exploit. Here, the sequence between receiving a friend request and going to game mode menu is unlikely to amount to an exploit or issue, so it can receive a lower score corresponding to the likelihood of an exploit.

Alternatively, an anomalous sequence of G-API calls can indicate uncommon user behavior among a video game application, and thereby serve as an identifier that a user associated with the G-API calls (e.g., causing a video game application to make the G-API calls) may be engaged in activities, such as exploits, that degrade the user experience for other users and/or players of the video game.

For example, as illustrated, anomaly report 430 includes G-API call sequences (from 410) corresponding to the gameplay of a user where the user receives a friend request, joining gameplay, trading items with the new friend, exiting gameplay, and deleting the new friend. Such G-API calls can indicate uncommon gameplay actions and/or behavior that degrades the user experience and/or violates the terms of service of a video game. As such, anomaly report 430 can be used to identify such users.

Additionally, an anomaly report can include game data 435, or pointers to game data 435, that correspond to state data, among other things, for the gameplay and/or actions corresponding to the G-API calls among the anomaly report. In some embodiments, game data 435 can be used to recreate or simulate the gameplay and/or actions that occurred, which can assist developers in further analyzing the gameplay anomaly.

### Computing Device

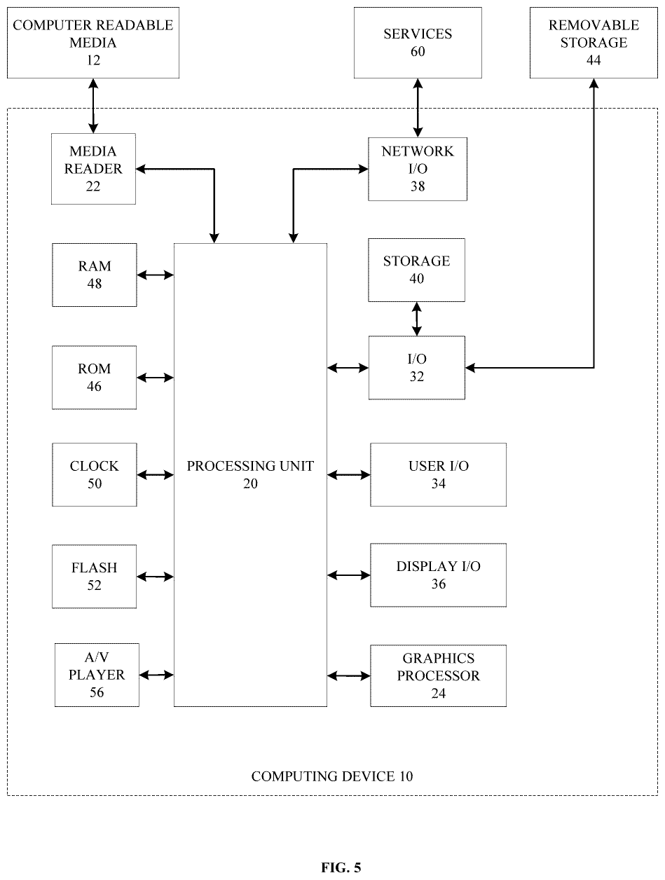

FIG. 5 illustrates an example embodiment of a computing device 10. In some embodiments, some or all of the aforementioned systems and computing devices—such as computing device 110 of FIG. 1—are similar to computing device 10. The example computing device 10 can store and/or execute computer executable instructions (or code) of applications (or programs or software), such as video game applications, interactive applications, and/or other applications known to those of skill in the art that could include or benefit from the systems and methods described herein.

Computing device 10 can be or include any one or a combination of systems known to those of skill in the art, including, for example, a desktop, laptop, game application platform, game console, virtual reality system, augmented reality system, television set-top box, television, network-enabled kiosk, car-console devices, computerized appliance, wearable device (e.g., smart watch, glasses with computing functionality), and wireless mobile devices (e.g., smart phones, PDAs, tablets) and other general-purpose computing devices known to those of skill in the art.

As shown, computing device 10 includes processing unit 20 that interacts with other components of the computing device 10 and external components. A media reader 22 communicates with computer readable media 12. The media reader 22 may be an optical disc reader capable of reading optical discs, such as DVDs or Blu Ray discs, or any other type of reader that can receive and read data from computer readable media 12. One or more of the computing devices may be used to implement one or more of the systems disclosed herein.

Computing device 10 may include a graphics processor 24. In some embodiments, the graphics processor 24 is integrated into the processing unit 20, such that the graphics processor 24 may share Random Access Memory (RAM) with the processing unit 20. Alternatively, or in addition, the computing device 10 may include a discrete graphics processor 24 that is separate from the processing unit 20. In some such cases, the graphics processor 24 may have separate RAM from the processing unit 20. Computing device 10 might be a video game console device, a general-purpose laptop or desktop computer, a smart phone, a tablet, a server, or other suitable system for executing software among graphics processor 24, such as a video game application.

Computing device 10 also includes various components for enabling input/output, such as an I/O 32, a user I/O 34, a display I/O 36, and a network I/O 38. I/O 32 interacts with storage element 40 and removable storage media 44 to provide storage for computing device 10. Processing unit 20 can communicate through I/O 32 to store data. In addition to storage 40 and removable storage media 44, computing device 10 is also shown including ROM (Read-Only Memory) 46 and RAM 48. RAM 48 may be used for data that is accessed frequently during execution of software.

User I/O 34 is used to send and receive commands between processing unit 20 and user devices, such as keyboards or game controllers. In some embodiments, the user I/O can include a touchscreen. The touchscreen can be a capacitive touchscreen, a resistive touchscreen, or other type of touchscreen technology that is configured to receive user input through tactile inputs from the user. Display I/O 36 provides input/output functions that are used to display images. Network I/O 38 is used for input/output functions for a network (e.g., receiving and sending network data communications). Network I/O 38 may be used during execution of software applications by computing device 10; such as when a video game application communicates with a game server over a network.

Display output signals produced by processing unit 20 and/or graphics processor 24 can be sent to display by display I/O 36, including signals for displaying visual content produced by computing device 10; such as display output rendered by a video game application, including graphics, GUIs, video, and/or other visual content. Computing device 10 may comprise one or more integrated displays configured to receive display output signals produced by display I/O 36. According to some embodiments, display output signals produced by display I/O 36 may also be output to one or more display devices external to computing device 10, such a display 16.

The computing device 10 can also include other features, such as a clock 50, flash memory 52, and other components. An audio/video player 56 might also be used to play a video sequence, such as a movie or other media as known to those of ordinary skill in the art. An audio/video player 56 may include or use software for encoding or decoding media for playback.

Computer executable instructions, applications, programs, or code (e.g., software) can be stored in ROM 46, RAM 48, media 12, and/or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media such as media 12 (which can be a CD-ROM, cartridge, memory chip or the like, or obtained over a network or other electronic channel as needed). In general, applications can be found embodied in a tangible non-transitory signal-bearing medium.

Random access memory (RAM) 48 (and possibly other storage) is usable to store variables and other processor data as needed. RAM is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the computing device 10 is turned off or loses power.

As computing device 10 reads media 12 and provides an application, information may be read from media 12 and stored in a memory device, such as RAM 48. Additionally, data from storage 40, ROM 46, services 60 accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

The disclosed subject matter can include an apparatus for performing the operations herein. This apparatus may be specially constructed for the required purposes, or it may comprise a general-purpose computer selectively activated or reconfigured by an application stored and/or executed by computing device 10. Such an application may be stored in a non-transitory computer readable medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The disclosed subject matter may include a non-transitory computer readable medium having stored thereon applications or instructions, which may be used (e.g., executed) to instruct a system or computing devices to perform a process according to the disclosed subject matter. A non-transitory computer readable medium includes any mechanism for storing or transmitting information in a form readable by a computing device and other systems of the like known to those of skill in the art.

The applications or instructions of computing device 10 can be stored and/or executed among a local environment and/or among in a distributed environment of computing devices, as known to those of skill in the art. Different applications can include varying instructions, components, graphical configurations, and/or data for supporting their runtime execution on different hardware (e.g., different types of computing devices).

A locally executed application does not rely on or use an external computing device (e.g., a system other than computing device 10) to execute the application. In some instances, a locally executable video game application can communicate with external systems or devices, such as external servers, to retrieve information associated with the video game, such as game patches, game authentication, cloud saves, user account data, previously trained model data, or other features.

In distributed implementations, computing device 10 may execute portions of a video game application, while other systems or devices such as external servers execute other portions of the video game application. For instance, massively multiplayer online role-playing games (MMORPGs) include client portions (e.g., video game application) of the video game executed by computing devices of or corresponding to users or players, and server portions executed by one or more servers. It should be understood that applications described herein can be a locally executable game or a distributed application.

The present disclosure may use machine learning. Machine learning is a subfield of artificial intelligence, which, to persons of ordinary skill of the art, corresponds to underlying algorithms and/or frameworks (commonly known as “neural networks” or “machine learning models”) that are configured and/or trained to perform and/or automate one or more tasks or computing processes. For simplicity, the terms “neural networks” and “machine learning models” can be used interchangeably and can be referred to as either “networks” or “models” in short.

The present disclosure may use deep learning. Deep learning is a subfield of artificial intelligence and machine learning, which, to persons of ordinary skill of the art, corresponds to multilayered implementations of machine learning (commonly known as “deep neural networks”). For simplicity, the terms “machine learning” and “deep learning” can be used interchangeably.

As known to a person of ordinary skill in the art, machine learning is commonly utilized for performing and/or automating one or more tasks such as identification, classification, determination, adaptation, grouping, and generation, among other things. Common types (e.g., classes or techniques) of machine learning include supervised, unsupervised, regression, classification, reinforcement, and clustering, among others.

Among these machine learning types are a number of model implementations, such as linear regression, logistic regression, evolution strategies (ES), convolutional neural networks (CNN), deconvolutional neural networks (DNN), generative adversarial networks (GAN), recurrent neural networks (RNN), and random forest, among others. As known to a person of ordinary skill in the art, one or more machine learning models can be configured and trained for performing one or more tasks at runtime of the model.

As known to a person of ordinary skill in the art, the output of a machine learning model is based at least in part on its configuration and training data. The data that models are trained on (e.g., training data) can include one or more data types. In some embodiments, the training data of a model can be changed, updated, and/or supplemented throughout training and/or inference (i.e., runtime) of the model.

The systems, methods, and/or computing devices of the present disclosure can include machine learning modules. A “machine learning module” is a software module and/or hardware module including computer-executable instructions to configure, train, and/or deploy (e.g., execute) one or more machine learning models.

Some aspects of the present disclosure include subject matter corresponding to the gameplay of video game applications. As known to a person of ordinary skill in the art, the gameplay of a video game is commonly known as occurring among a game session within one or more instances of one or more virtual interactive environments. The gameplay of a video game provides interactivity with one or more aspects of a video game.

A game session may include a number of player characters and/or non-player characters. As known to those of skill in the art, player characters are character models that can be controlled or directed (at least primarily) by users or players through inputs at their respective computing devices and can perform gameplay actions or commands. “Non-player characters” (also referred to herein as “NPCs”) are characters that are not or cannot be controlled and/or directed (primarily by users or players). Rather, NPCs can be configured with computer executable instructions to perform one or more gameplay tasks and/or actions, with and/or without the need for input or interaction from a user/player or player character.

A game session may include a number of player objects. Player objects can refer to controllable objects, or models, used to facilitate or enable gameplay or other in-game actions. Player objects may be, for example, vehicles, vessels, aircraft, ships, tiles, cards, dice, pawns, and other in-game items of the like known to those of skill in the art. In some embodiments, a user or player can control or direct one or more player objects in a game session, including, in some instances, by controlling player characters which in turn causes the objects to be controlled.

For simplicity, player characters and player objects disclosed are collectively referred to herein as player characters in some embodiments. It should be understood that, as used herein, “controllable” refers to the characteristic of being able and/or configured to be controlled and/or directed (e.g., moved, modified, etc.) by a player or user through one or more input means, such as a controller or other input device, by a player or user. As known to a person of ordinary skill in the art, player characters include character models configured to receive input.

Some aspects of the present disclosure include subject matter corresponding to the data of video game applications. As known to a person of ordinary skill in the art, game data is data corresponding to one or more aspects of a video game application. Game data includes data such as state data, simulation data, rendering data, digital assets, and other data of the like.

State data is commonly known as data describing a state of a player character, virtual interactive environment, and/or other virtual objects, actors, or entities—in whole or in part—at one or more instances or periods of time during a game session of a video game. For example, state data can include the current location and condition of one or more player characters among a virtual interactive environment at a given time, frame, or duration of time or number of frames.

Simulation data is commonly known as the underlying data corresponding to simulation (e.g., physics and other corresponding mechanics) to drive the simulation of a model or object in a game engine. For example, simulation data can include the joint and structural configuration of a character model and corresponding physical forces or characteristics applied to it at instance or period of time during gameplay, such as a “frame”, to create animations, among other things.

Render Data is commonly known as the underlying data corresponding to rendering (e.g., visual and auditory rendering) aspects of a game session, which are rendered (e.g., for output to an output device) by a game engine. For example, render data can include data corresponding to the rendering of graphical, visual, auditory, and/or haptic output of a video game, among other things.

Game data can also include digital game assets. For instance, game assets can include virtual objects, character models, actors, entities, geometric meshes, textures, terrain maps, animation files, audio files, digital media files, font libraries, visual effects, and other digital assets commonly used in video games of the like.

In some embodiments, a game session is based in part on game data. During a game session, one or more aspects of gameplay (e.g., rendering, simulation, state, gameplay actions of player characters) uses, produces, generates, and/or modifies game data. Likewise, gameplay events, objectives, triggers, and other aspects, objects, or elements of the like also use, produce, generate, and/or modify game data.

Game data may be updated, versioned, and/or stored periodically as a number of files to a computing device. Additionally, game data, or copies and/or portions thereof, can be stored, referenced, categorized, or placed into a number of buffers or storage buffers. A buffer can be configured to capture particular data, or data types, of game data for processing and/or storage. For simplicity, the terms “data”, “game data”, “game data”, “state data”, “simulation data”, and “render data” can be used interchangeably to refer to the data of, or corresponding to, a video game.

Some aspects of the present disclosure include subject matter corresponding to video games, including video game components corresponding to the software of a video game. As known to a person of ordinary skill in the art, game code is software defining the gameplay, features, and aspects of a video game whereas a game engine provides underlying frameworks and software that support and facilitate execution of the game code (e.g., gameplay)

As a non-limiting descriptive example, a game engine includes, among other things, a renderer, simulator, and stream layer. A game engine uses game data (e.g., state data, render data, simulation data, audio data, and other data types of the like) to generate and/or render one or more outputs (e.g., visual output, audio output, and haptic output) for one or more computing devices. In some embodiments, a game engine is a distributable computer executable runtime portion of a development client, such as a video game development engine.

A renderer is a graphics framework that manages the production of graphics corresponding to lighting, shadows, textures, user interfaces, and other effects to game assets of the like among a game engine. A simulator refers to a framework that manages simulation aspects corresponding to physics and other corresponding mechanics used in part for animations and/or interactions of gameplay objects, entities, characters, lighting, gasses, and other game assets or effects of the like. A stream layer is a software layer that allows a renderer and simulator to execute independently of one another among a game engine by providing a common execution stream for renderings and simulations to be produced and/or synchronized (e.g., scheduled) at and/or during runtime.

A game engine also includes an audio engine or audio renderer that produces and synchronizes audio playback with or among the common execution of a stream layer. For example, an audio engine of a game engine can use game data to produce audio output and/or haptic output from game data.

As used herein in some embodiments, video game applications can also use and/or include Software Development Kits (SDKs), Application Program Interfaces (APIs), Dynamically Linked Libraries (DLLs), and other software libraries, components, modules, shims, or plugins that provide and/or enable a variety of functionality; such as—but not limited to—graphics, audio, font, or communication support, establishing and maintaining service connections, performing authorizations, and providing anti-cheat and anti-fraud monitoring and detection, among other things.

Some portions of the detailed descriptions above are presented in terms of symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated (e.g., among a computing device). It has proven convenient at times, principally for reasons of common usage, to refer to these signals as bits, values, elements, symbols, characters, terms, numbers, or the like.

One set of example embodiments of the disclosure can be described by the following clauses:
Clause 1. A system comprising: at least one processor; and at least one memory device, wherein the at least one memory device is communicatively coupled to the at least one processor, the at least one memory device storing computer-executable instructions, wherein execution of the computer-executable instructions by the at least one processor causes the at least one processor to: receive a plurality of application programming interface calls of a video game (“G-API calls”) corresponding to gameplay of the video game; embed the plurality of G-API calls received; detect one or more anomalous sequences of G-API calls among the plurality of embedded G-API calls; and, generate an anomaly report including data corresponding to the one or more anomalous sequences of G-API calls detected.
Clause 2. The system of clause 1, wherein the plurality of G-API calls correspond to one or more user accounts of a video game.
Clause 3. The system of clause 2, wherein the computer-executable instructions further configure the at least one processor to embed each G-API call among the plurality of G-API calls based at least in part on a string of each G-API call.
Clause 4. The system of clause 3, wherein the embedding of each G-API call among the plurality of G-API calls is based at least in part on a semantic similarity determined by a trained machine learning model.
Clause 5. The system of clause 4, wherein the trained machine learning model is trained based at least in part on training data including G-API calls.
Clause 6. The system of clause 5, wherein the trained machine learning model is trained to determine semantic similarity based at least in part on an order of the G-API calls in the training data.
Clause 7. The system of clause 1, wherein the anomaly report includes data corresponding to one or more user accounts associated with the one or more anomalous sequences of G-API calls detected.
Clause 8. A computer implemented method comprising: receiving a plurality of application programming interface calls of a video game (“G-API calls”) corresponding to gameplay of the video game; embedding the plurality of G-API calls received; detecting one or more anomalous sequences of G-API calls among the plurality of embedded G-API calls; and, generating an anomaly report including data corresponding to the one or more anomalous sequences of G-API calls detected.
Clause 9. The computer implemented method of clause 8, wherein the plurality of G-API calls correspond to one or more user accounts of a video game.
Clause 10. The computer implemented method of clause 9 further comprising embedding each G-API call among the plurality of G-API calls based at least in part on a string of each G-API call.
Clause 11. The computer implemented method of clause 10, wherein the embedding each G-API call among the plurality of G-API calls is based at least in part on a semantic similarity determined by a trained machine learning model.
Clause 12. The computer implemented method of clause 11, wherein the trained machine learning model is trained based at least in part on training data including G-API calls.
Clause 13. The computer implemented method of clause 12, wherein the trained machine learning model is trained to determine semantic similarity based at least in part on an order of the G-API calls in the training data.
Clause 14. The computer implemented method of clause 8, wherein the anomaly report includes data corresponding to one or more user accounts associated with the one or more anomalous sequences of G-API calls detected.
Clause 15. A non-transitory computer readable medium storing computer-executable instructions, wherein, when executed, the computer-executable instructions configure at least one processor to: receiving a plurality of application programming interface calls of a video game (“G-API calls”) corresponding to gameplay of the video game; embedding the plurality of G-API calls received; detecting one or more anomalous sequences of G-API calls among the plurality of embedded G-API calls; and, generating an anomaly report including data corresponding to the one or more anomalous sequences of G-API calls detected.
Clause 16. The non-transitory computer readable medium of clause 15, wherein the plurality of G-API calls correspond to one or more user accounts of a video game.
Clause 17. The non-transitory computer readable medium of clause 16, wherein the computer-executable instructions further configure the at least one processor to embed each G-API call among the plurality of G-API calls based at least in part on a string of each G-API call.
Clause 18. The non-transitory computer readable medium of clause 17, wherein the embedding of each G-API call among the plurality of G-API calls is based at least in part on a semantic similarity determined by a trained machine learning model.
Clause 19. The non-transitory computer readable medium of clause 18, wherein the trained machine learning model is trained based at least in part on training data including G-API calls.
Clause 20. The non-transitory computer readable medium of clause 19, wherein the trained machine learning model is trained to determine semantic similarity based at least in part on an order of the G-API calls in the training data.

Certain example embodiments are described above to provide an overall understanding of the principles of the structure, function, manufacture and use of the devices, systems, and methods described herein. One or more examples of these embodiments are illustrated in the accompanying drawings. Those skilled in the art will understand that the descriptions herein and the accompanying drawings are intended to be illustrative, and not restrictive. Many other implementations will be apparent to those of skill in the art based upon the above description. Such modifications and variations are intended to be included within the scope of the present disclosure. The scope of the present disclosure should, therefore, be considered with reference to the claims, along with the full scope of equivalents to which such claims are entitled. The features illustrated or described in connection with one exemplary embodiment may be combined with the features of other embodiments. In some instances, well-known structures and devices are shown in block diagram form, rather than in detail, in order to avoid obscuring the disclosed subject matter.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A system comprising:
at least one processor; and
at least one memory device, wherein the at least one memory device is communicatively coupled to the at least one processor, the at least one memory device storing computer-executable instructions, wherein execution of the computer-executable instructions by the at least one processor causes the at least one processor to:
receive a plurality of application programming interface calls of a video game (“G-API calls”) corresponding to gameplay of the video game;
embed the plurality of G-API calls received;
detect one or more anomalous sequences of G-API calls among the plurality of embedded G-API calls; and,
generate an anomaly report including data corresponding to the one or more anomalous sequences of G-API calls detected.

2. The system of claim 1, wherein the plurality of G-API calls correspond to one or more user accounts of a video game.

3. The system of claim 2, wherein the computer-executable instructions further configure the at least one processor to embed each G-API call among the plurality of G-API calls based at least in part on a string of each G-API call.

4. The system of claim 3, wherein the embedding of each G-API call among the plurality of G-API calls is based at least in part on a semantic similarity determined by a trained machine learning model.

5. The system of claim 4, wherein the trained machine learning model is trained based at least in part on training data including G-API calls.

6. The system of claim 5, wherein the trained machine learning model is trained to determine semantic similarity based at least in part on an order of the G-API calls in the training data.

7. The system of claim 1, wherein the anomaly report includes data corresponding to one or more user accounts associated with the one or more anomalous sequences of G-API calls detected.

8. A computer implemented method comprising:
receiving a plurality of application programming interface calls of a video game (“G-API calls”) corresponding to gameplay of the video game;
embedding the plurality of G-API calls received;
detecting one or more anomalous sequences of G-API calls among the plurality of embedded G-API calls; and,
generating an anomaly report including data corresponding to the one or more anomalous sequences of G-API calls detected.

9. The computer implemented method of claim 8, wherein the plurality of G-API calls correspond to one or more user accounts of a video game.

10. The computer implemented method of claim 9 further comprising embedding each G-API call among the plurality of G-API calls based at least in part on a string of each G-API call.

11. The computer implemented method of claim 10, wherein the embedding each G-API call among the plurality of G-API calls is based at least in part on a semantic similarity determined by a trained machine learning model.

12. The computer implemented method of claim 11, wherein the trained machine learning model is trained based at least in part on training data including G-API calls.

13. The computer implemented method of claim 12, wherein the trained machine learning model is trained to determine semantic similarity based at least in part on an order of the G-API calls in the training data.

14. The computer implemented method of claim 8, wherein the anomaly report includes data corresponding to one or more user accounts associated with the one or more anomalous sequences of G-API calls detected.

15. A non-transitory computer readable medium storing computer-executable instructions, wherein, when executed, the computer-executable instructions configure at least one processor to:
receiving a plurality of application programming interface calls of a video game (“G-API calls”) corresponding to gameplay of the video game;
embedding the plurality of G-API calls received;
detecting one or more anomalous sequences of G-API calls among the plurality of embedded G-API calls; and,
generating an anomaly report including data corresponding to the one or more anomalous sequences of G-API calls detected.

16. The non-transitory computer readable medium of claim 15, wherein the plurality of G-API calls correspond to one or more user accounts of a video game.

17. The non-transitory computer readable medium of claim 16, wherein the computer-executable instructions further configure the at least one processor to embed each G-API call among the plurality of G-API calls based at least in part on a string of each G-API call.

18. The non-transitory computer readable medium of claim 17, wherein the embedding of each G-API call among the plurality of G-API calls is based at least in part on a semantic similarity determined by a trained machine learning model.

19. The non-transitory computer readable medium of claim 18, wherein the trained machine learning model is trained based at least in part on training data including G-API calls.

20. The non-transitory computer readable medium of claim 19, wherein the trained machine learning model is trained to determine semantic similarity based at least in part on an order of the G-API calls in the training data.
